(19) United States
(12) Patent Application Publication
(10) Pub. No.: US 2018/0023638 A1
(43) Pub. Date: Jan. 25, 2018

(54) BELT PULLEY DECOUPLER

(71) Applicant: SCHAEFFLER TECHNOLOGIES AG & CO. KG, Herzogenaurach (DE)

(72) Inventors: Michael KASTNER, Erlangen (DE); Roland ARNETH, Eggolsheim (DE)

(73) Assignee: SCHAEFFLER TECHNOLOGIES AG & CO. KG, Herzogenaurach (DE)

(21) Appl. No.: 15/547,089

(22) PCT Filed: Jan. 28, 2016
(86) PCT No.: PCT/DE2016/200060

§ 371 Date: Jul. 28, 2017

(30) Foreign Application Priority Data
Feb. 12, 2015 (DE) 10 2015 202 527.6

(51) Int. Cl. F16D 41/20; F16D 43/20

(52) U.S. Cl. CPC F16D 41/206; F16D 43/20

(57) ABSTRACT

A belt pulley decoupler is provided for transmitting a drive torque from the belt of an auxiliary unit belt drive to the shaft of one of the auxiliary units. The decoupler a belt pulley, a hub fixed on the shaft, and a one-way clutch and a coil torsion spring arranged in series in the drive torque flow between the belt pulley and the hub. The spring extends about the axis of rotation of the belt pulley decoupler and widens radially under transmission of a drive torque. The ends of the coil torsion spring contact respective axially ascending ramp-shaped spring support surface of a first spring plate and of a second spring plate. At least one of the spring plates is a sheet metal shaped part having a spring support surface integrally formed thereon.

### CROSS-REFERENCE TO RELATED APPLICATIONS

This application is the U.S. National Phase of PCT/DE2016/200060 filed Jan. 28, 2016, which claims priority to DE 102015202527.6 filed Feb. 12, 2015, the entire disclosures of which are incorporated by reference herein.

### TECHNICAL FIELD

This disclosure relates to a belt pulley decoupler for transmitting a drive torque from the belt of an auxiliary unit belt drive to the shaft of one of the auxiliary units.

### BACKGROUND

As known, torsional vibrations and cyclic irregularities which are introduced by the crankshaft of an internal combustion engine into its auxiliary unit belt drive can be compensated by belt pulley decouplers, usually designated as decouplers in English, and typically configured as generator belt pulleys. In the engaged state, the one-way clutch transmits the drive torque from the belt pulley to the hub, and the elasticity of the one-way clutch connected in series with the coil torsion spring smooths the cyclic irregularities originating in the belt drive. When the rotation of the belt pulley is retarded, the one-way clutch disengages, so that, in reverse, no noteworthy torque can be transmitted from the hub to the belt pulley, so that the inert generator shaft can overrun the belt pulley.

DE 10 2009 052 611 A1 discloses a belt pulley decoupler with a radially inner one-way clutch and a radially outer coil torsion spring. A belt pulley decoupler with an exchanged radial arrangement of the one-way clutch and the coil torsion spring with respect to the above arrangement is disclosed for example in U.S. Pat. No. 8,047,920 B2. The coil torsion spring possesses respective legless ends whose front faces are situated in pressure contact with steps of the axially ascending ramp-shaped spring support surfaces.

Based on this, it is the object of the present disclosure to propose a belt pulley decoupler of the type described above with a simplified constructive configuration.

### SUMMARY

This disclosure achieves the above object through the features described in claim 1. According to these features, at least one of the spring plates should be a sheet metal shaped part with the spring support surface formed thereon. Thus one, or preferably both ends of the coil torsion spring bear directly against spring plates that are configured as sheet metal shaped parts, so that with regard to the ramp-shaped support surfaces, the hitherto usual embodiments both of a cost-intensive spring plate made by creative forming and of a spring plate with a separate ramp-shaped additional component can be substituted with a one-piece sheet metal shaped part.

### BRIEF DESCRIPTION OF THE DRAWINGS

Further features of this disclosure will become obvious from the following description and the attached drawings in which an example of embodiment of a belt pulley decoupler according to this disclosure for the generator arranged in the auxiliary unit belt drive of an internal combustion engine.

FIG. 1 illustrates a belt pulley decoupler in a perspective view;

FIG. 2 illustrates the belt pulley decoupler in a perspective longitudinal cross-sectional view;

FIG. 3 illustrates the belt pulley decoupler in an exploded view;

FIG. 4 illustrates a component group made up of the belt pulley and a sleeve in an exploded view;

FIG. 5 illustrates the component group of FIG. 4 in a longitudinal cross-sectional view;

FIG. 6 illustrates the sleeve in a perspective view;

FIG. 7 illustrates an alternative sleeve in a perspective view;

FIG. 8 illustrates a further alternative sleeve in a perspective view;

FIG. 9 illustrates the first spring plate in a perspective view;

FIG. 10 illustrates the first spring plate in an opposing perspective view;

FIG. 11 illustrates an entraining disk in a perspective view;

FIG. 12 illustrates a thrust washer in a perspective view;

FIG. 13 illustrates the component group made up of the hub and the second spring plate in an exploded representation;

FIG. 14 illustrates the component group of FIG. 13 in a perspective longitudinal cross-section view;

FIG. 15 illustrates the second spring plate in a perspective representation;

FIG. 16 illustrates the second spring plate in an opposing perspective representation.

### DETAILED DESCRIPTION

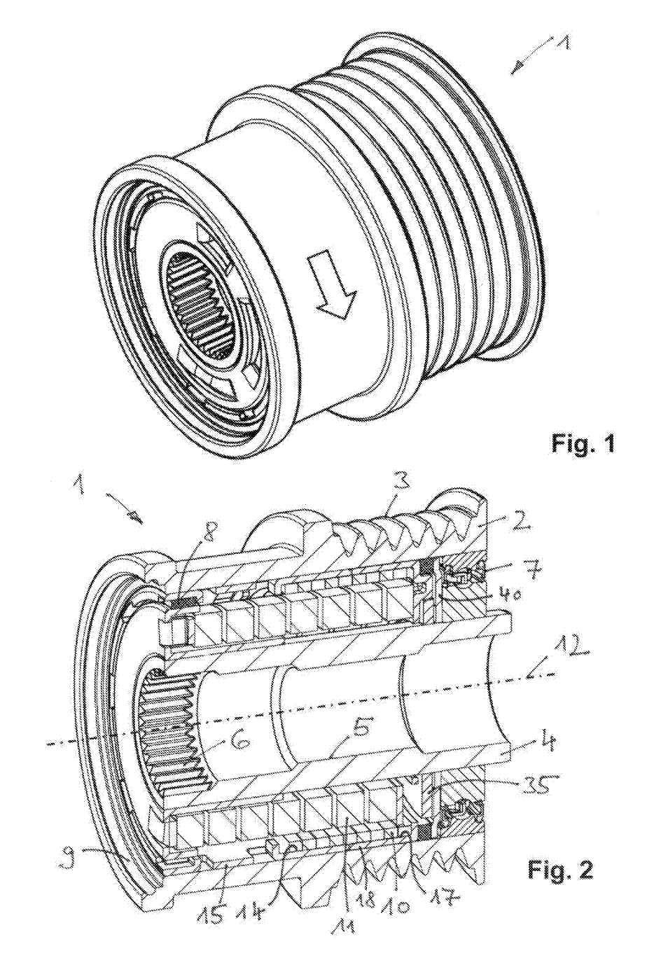

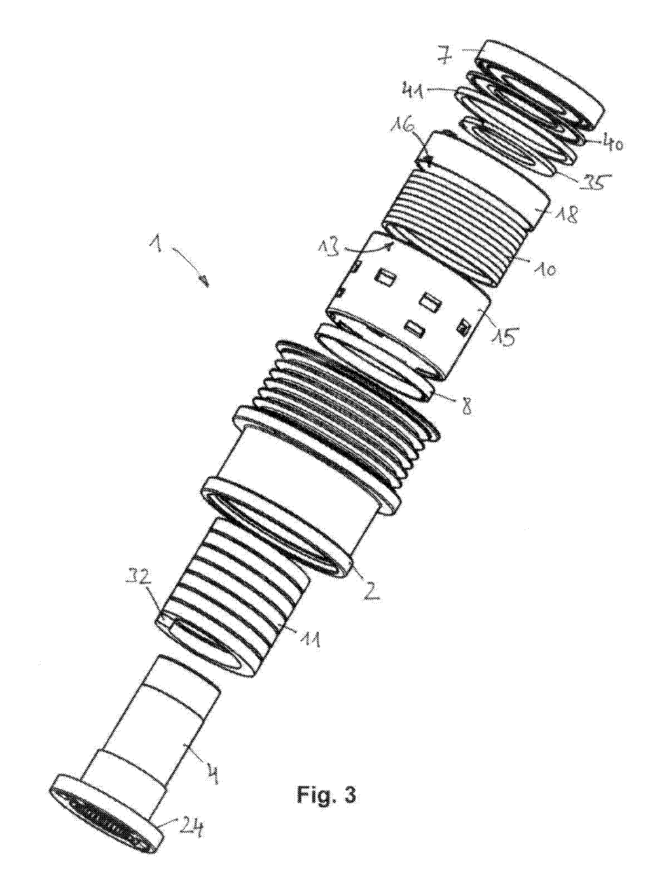

FIGS. 1 to 3 show the belt pulley decoupler 1, referred to hereinafter as decoupler 1, in various perspective representations, namely as a complete entity in FIG. 1, in a longitudinal cross-section in FIG. 2 and as an exploded representation in FIG. 3. A hollow cylindrical belt pulley 2, whose outer peripheral surface 3 is wrapped around by the belt and profiled in correspondence to the poly-V-shape of the belt, is driven by the belt in the direction of rotation shown graphically in FIG. 1. The belt pulley 2 is rotatably mounted on a hub 4 that is fixedly screwed onto the generator shaft. For this purpose, the hub 4 possesses in its the central portion 5 an inner thread, not shown, and on its generator-distal front end portion, a polygonal toothing 6 as an engagement contour for the screwing tool. Mounting of the belt pulley 2 on the hub 4 is realized radially and axially on the generator-side end with help of a rolling bearing 7, and on the generator-distal end radially with help of a sliding bearing 8. The rolling bearing 7 is a one-row ball bearing sealed on both sides, and the sliding bearing 8 is a radial bearing ring made of polyamide. The inner diameter of the belt pulley 2 is uniform throughout the entire region between the radial bearing ring 8 and the ball bearing 7, so that this inner diameter region is accessible for a particularly simple and economic turning machining. It is only on the generator-distal end, that the belt pulley 2 possesses a widening 9 with a graduated diameter into which, after the mounting of the decoupler 1 on the generator, a protection cap, not shown, is snapped in.

The decoupler 1 includes a one-way clutch 10 and a decoupler spring 11 connected—with respect to the drive torque flow from the belt pulley 2 to the hub 4—in series with the one-way clutch 10. The one-way clutch 10 is a wrap-around band and the decoupler spring 11 is a coil torsion spring, both of which extend in direction of the axis of rotation 12 of the decoupler 1. In the present example, the coil torsion spring 11 and the wrap-around band 10 are coaxial with the axis of rotation 12, the wrap-around band 10 extending in the radial annular space between the belt pulley 2 and the coil torsion spring 11.

The clockwise wound wrap-around band 10 and the counter-clockwise wound coil torsion spring 11 are both wholly cylindrical in shape and have legless ends on both sides, which legs, as a consequence, widen the wrap-around band and the coil torsion spring respectively in radial direction during transmission of the drive torque. During this process, the first end 13 of the wrap-around band arranged on the belt pulley-side in the drive torque flow gets braced against the cylindrical inner peripheral surface 14 of a sleeve 15 that is rotationally fixed in the belt pulley 2. The second end 16 of the wrap-around band extending on the coil torsion spring-side in the drive torque flow gets braced against the cylindrical inner peripheral surface 17 of a first spring plate 18 that is rotatably arranged in the belt pulley 2. Thus, the drive torque introduced by the belt pulley 2 is introduced into the coil torsion spring 11 and transmitted from there to the hub 4 exclusively through static friction, on the one side, between the inner peripheral surface 14 of the sleeve 15 and the first end 13 of the wrap-around band 10 and, on the other side, between the second end 16 of the wrap-around band 10 and the inner peripheral surface 17 of the first spring plate 18.

At reversal of the drive torque, the wrap-around band 10 enables an overrunning of the generator shaft and of the hub 4 fixed thereon with respect to the belt pulley 2. In this state, the wrap-around band 10 contracts to its (non-loaded) original outer diameter and slips-through in the sleeve 15 and/or in the first spring plate 18, and during this time, the transmittable drive torque is reduced to the level of the sliding friction torque pre-vailing between the two slipping-through contact partners.

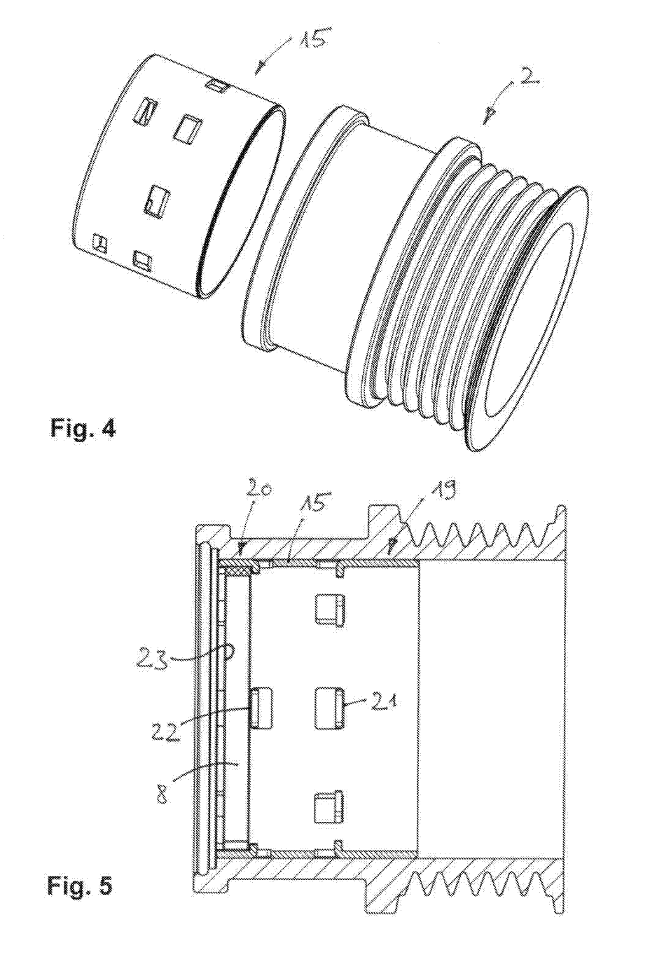

FIGS. 4 and 5 show an exploded and a longitudinal cross-sectional view, respectively of the sub-assembly made up of the belt pulley 2, the sleeve 15 pressed onto the inner diameter of the pulley and the radial bearing ring 8. As recognizable in a combined viewing with FIG. 2, the sleeve 15 has a first axial portion 19 in which the first end 13 of the wrap-around band extends, and a second axial portion 20 in which the radial bearing ring 8 is received. In one embodiment, the sleeve 15 is a sheet metal shaped part and comprises on its periphery radially inwards formed projections that constitute axial stops 21, 22 and 23. The first axial portion 19 is delimited by the axial stop 21 for the wrap-around band 10, and the second axial portion 20 is delimited on both sides by the axial stops 22 and 23 respectively for the radial bearing ring 8. For the purpose of mounting between the two axial stops 22, 23 the radial bearing ring 8 is slit on its periphery.

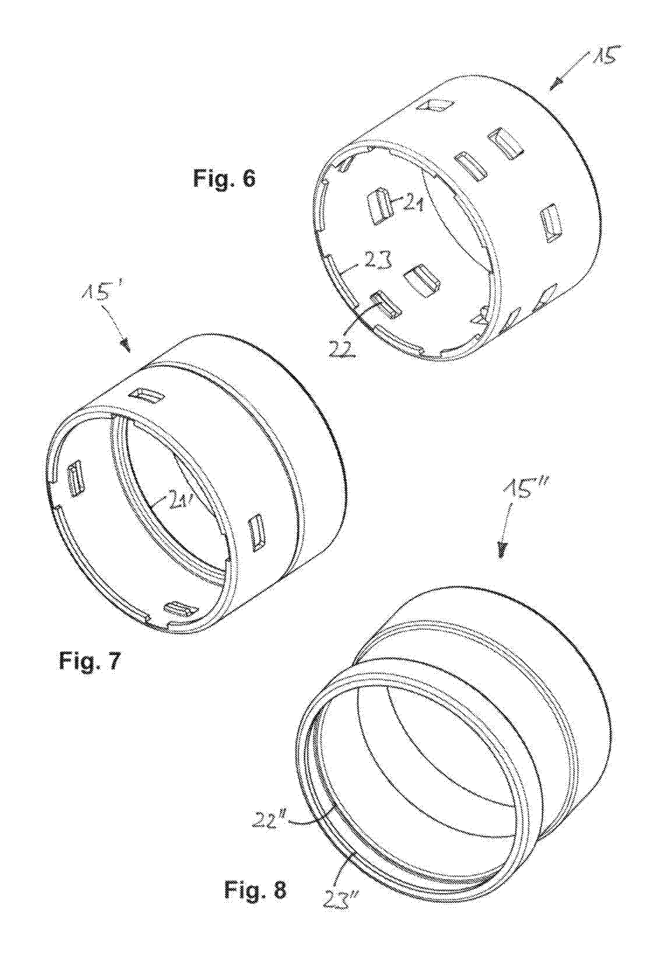

Each of the projections of the sleeve 15, shown as an enlarged separate part in FIGS. 4 to 6, forming the axial stops 21, 22, comprises a plurality of local stampings in the peripheral surface of the sleeve, and the outer axial stop 23 for the radial bearing ring 8, comprises a collar with a plurality of circumferentially spaced segments.

The sleeves 15′ and 15″ according to FIGS. 7 and 8 possess an alternative configuration to the above described configuration. In the case of the sleeve 15′, the axial stop 21′ for the wrap-around band 10 is replaced with a roller-burnished step extending along the periphery of the sleeve and, in the case of the sleeve 15″, additionally, the inner axial stop 22″ for the radial bearing ring 8 is also replaced with such a roller-burnished step. Besides this, the outer axial stop 23″ for the radial bearing ring 8 is made in form of a peripherally continuous collar.

In a further alternative embodiment, (not shown), the second axial portion 20 of the then adequately shortened sleeve 15 can also be omitted, so that, in this case, the radial bearing ring 8 would be received directly on the inner diameter of the belt pulley 2.

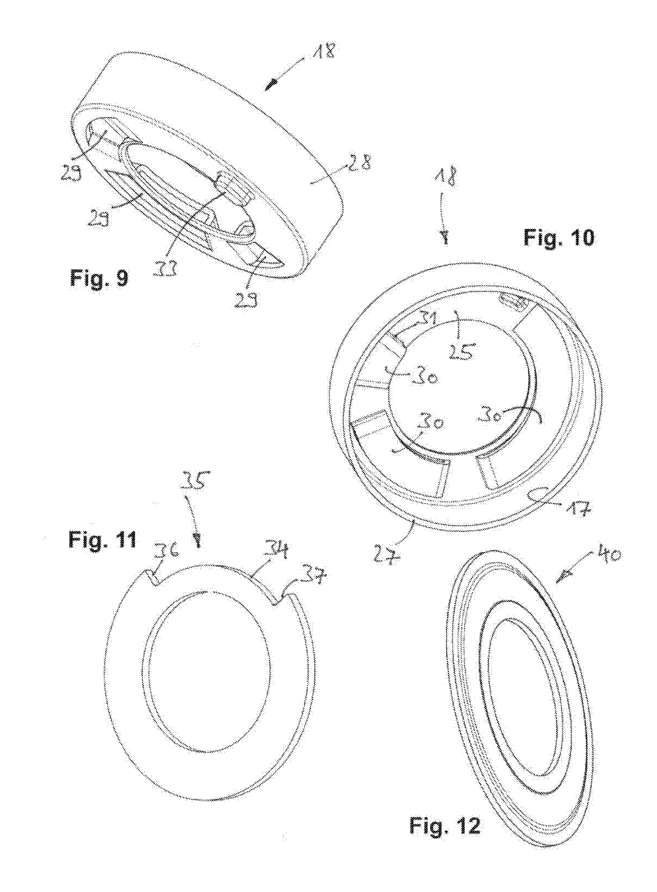

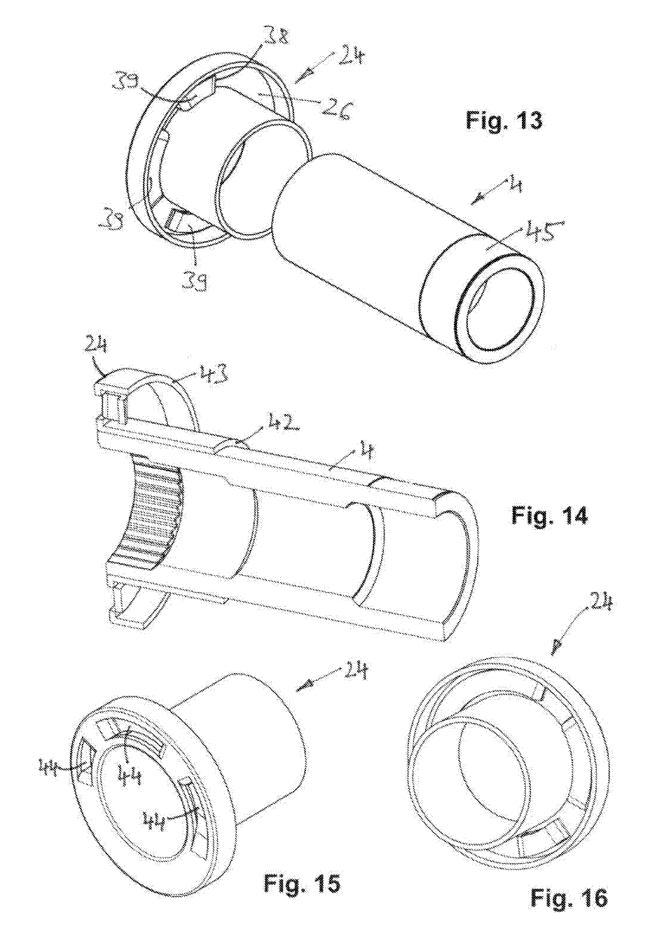

The coil torsion spring 11 is clamped-in between the first spring plate 18 and a second spring plate 24 (see FIG. 13) with a slight axial bias. The spring plates 18, 24 are like-wise sheet metal shaped parts and comprise, each one, a collar 25 and 26 respectively that contact the associated and, according to FIG. 3, legless ends of the coil torsion spring 11. The first spring plate 18, shown as an enlarged separate part in FIGS. 9 and 10, comprises an outer ring 27 in whose inner peripheral surface 17 the second end 16 of the coil torsion spring is looped and on whose outer peripheral surface 28 the first spring plate 18 is rotatably mounted on the inner diameter of the belt pulley 2. The collar 25 is provided with three stampings 29 formed thereon that form an axial ramp-shaped ascending spring support surface 30. This enables the torque introduction into the coil torsion spring end resting directly thereon.

The peripherally spaced stampings 29 are circular arc-shaped with the length of their arcs shortening with increasing axial elevation. Thus, the transmission of the drive torque takes place from the step 31, descending at the stamping 29 with the shortest arc length, to the front face of the coil torsion spring end resting thereon and radially widening the coil torsion spring. In one embodiment, this front face is formed exactly like the front face 32, visible in FIG. 3, of the other end of the coil torsion spring. Alternatively to the (laterally open) stampings 29, it is also conceivable for the spring support surface 30 to be formed by one or more (laterally closed) beads.

The front face of the collar 25 of the first spring plate 18 turned away from the coil torsion spring 11 comprises a projection 33 formed thereon that engages into a circular arc-shaped recess 34 of an entraining disk 35 according FIG. 5 seated non rotatably on the hub 4 and able to pivot between the peripheral ends 36 and 37 of the recess 34. The peripheral end 36 lagging in direction of the rotation of the decoupler 1 is positioned such that, in overrunning operation of the generator and against the friction torque of the then slipping-through wrap-around band 10, this end 36 entrains the first spring plate 18 via the projection 33. In this state, the first spring plate 18 and the hub 4, together with the second spring plate 24 fixed non-rotatably fixed thereon, rotate, as it were, as a rigid unit and thus prevent the so-called “ramp-up” of the ends of the coil torsion spring. This event threatens to occur when the first spring plate 18 and second spring plate 24 twist relative to each other upon peripheral relaxation of the coil torsion spring 11, so that one or both front faces 32 of the coil torsion spring ends move away from the steps 31 and 38 of the spring support surfaces 30 and 39, respectively, (see FIG. 13) and migrate upwards along the spring support surfaces 30, 39. The design space for the coil torsion spring 11 diminishing in axial direction during this process can cause the coil torsion spring 11 to impermissibly press the two spring plates 18 and 24 away from each other and thus, so to speak, axially burst the decoupler 1 apart.

As will become clear in a combined viewing with FIG. 2, the axial support of the first spring plate 18 is accomplished on the ball bearing 7 and not on the entraining disk 35 that is positioned on the hub 4 with a respective axial clearance to the first spring plate 18 on the one side and to a thrust washer 40, shown in FIG. 12, on the other side and is consequently free of axial load. The axial load is much rather transmitted from the first spring plate 18 to a slide mounted polyamide axial bearing ring 41 and, further, via the thrust washer 40 that is bent at an angle radially inwards towards the ball bearing 7, to the inner ring of the ball bearing 7.

FIGS. 13 to 16 show the second spring plate 24 assembled with the hub 4 or as an individual part, as the case may be. The second spring plate 24 is pressed onto the hub 4 through an inner ring 42 angularly bent from the collar 26, the third sleeve 24 also comprising an outer ring 43 bent angularly from the intermediately arranged collar 26, on which outer ring 43 the radial bearing ring 8 is received (see also FIG. 2). The axial ramp-shaped ascending spring support surface 39 is likewise formed by three stampings 44 that are formed on the collar 26, and this support surface likewise rests directly on the coil torsion spring end extending in this region, with the step 38 being exclusively in pressure contact with the front face 32 of the coil torsion spring end.

For enabling a simple turning machining, the hub 4 possesses a substantially uniform outer diameter that is slightly receded only on the generator-side hub end and forms a shoulder 45 for the inner ring of the ball bearing 7 pressed thereon (see FIG. 2) at this location.

### LIST OF REFERENCE NUMERALS

1 Belt pulley decoupler/decoupler

2 Belt pulley

3 Outer peripheral surface of the belt pulley

4 Hub

5 Central portion of the hub

6 Inner polygonal toothing

7 Rolling bearing/ball bearing

8 Sliding bearing/radial bearing ring

9 Widening

10 One-way clutch/wrap-around band

11 Decoupler spring/coil torsion spring

12 Axis of rotation

13 First end of wrap-around band

14 Inner peripheral surface of the sleeve

15 Sleeve

16 Second end of wrap-around band

17 Inner peripheral surface of the first spring plate

18 First spring plate

19 First axial portion

20 Second axial portion

21 Axial stop

22 (inner) Axial stop

23 (outer) Axial stop

24 Second spring plate

25 Collar of the first spring plate

26 Collar of the second spring plate

27 Outer ring of the first spring plate

28 Outer peripheral surface of the outer ring

29 Stamping

30 Spring support surface

31 Step

32 Front face of the coil torsion spring end

33 Projection

34 Recess

35 Entraining disk

36 End of the recess

37 End of the recess

38 Step

39 Spring support surface

40 Thrust washer

41 Axial bearing ring

42 Inner ring of the second spring plate

43 Outer ring of the second spring plate

44 Stamping

45 Shoulder of the hub

1. A belt pulley decoupler for transmitting a drive torque from a belt of an auxiliary unit belt drive to a shaft of an auxiliary unit, the belt pulley decoupler comprising:
a belt pulley;
a hub configured to be fixed on the shaft; and
a one-way clutch and a torsion coil spring arranged in series along a drive torque flow path between the belt pulley and the hub, the torsion coil spring extending in a direction of an axis of rotation of the belt pulley decoupler and widening radially under transmission of drive torque, wherein ends of the torsion coil spring contact an axially ascending ramp-shaped spring support surface of a first spring plate and of a second spring plate;
wherein at least one of the spring plates is a sheet metal shaped part with its spring support surface formed thereon.

2. The belt pulley decoupler according to claim 1, wherein the spring support surfaces are formed by circular arc-shaped stampings peripherally spaced from each other, or by beads in the sheet metal shaped part.

3. The belt pulley decoupler according to claim 1, wherein the one-way clutch is a wrap-around band that extends in the direction of the axis of rotation while being arranged radially between the belt pulley and the torsion coil spring, and wherein first and second ends of the wrap-around band widen radially under transmission of the drive torque, the first end extending on a belt pulley-side is braced against an inner peripheral surface rotationally fixed in the belt pulley, and the second end extending on a torsion coil spring-side braced against an inner peripheral surface of an outer ring of the first spring plate, the first spring plate comprising a collar and one of the spring support surfaces formed thereon, and is mounted in the belt pulley for rotating on an outer peripheral surface of the outer ring.

4. The belt pulley decoupler according to claim 3, wherein the first spring plate includes, on a front face of the collar facing away from the torsion coil spring, an integrally formed projection that can pivot between peripheral ends of a circular arc-shaped recess in an entraining disk that is rotationally fixed on the hub.

5. The belt pulley decoupler according to claim 4, wherein the entraining disk is arranged free of axial load between the first spring plate and a rolling bearing through which the belt pulley is mounted on the hub, the first spring plate being supported on the rolling bearing via an axial bearing ring and a thrust washer.

6. The belt pulley decoupler according to claim 3, wherein the wrap-around band end is braced against an inner peripheral surface of a sleeve that is rotationally fixed in the belt pulley, wherein the sleeve possesses a first axial portion in which the wrap-around band end extends, and in which a radial bearing ring is received that slidingly mounts the belt pulley on the hub.

7. The belt pulley decoupler according to claim 6, wherein the first axial portion includes one or more first axial stops for limiting the wrap-around band, and a second axial portion includes one or more second axial stops for limiting the radial bearing ring, wherein the sleeve is a sheet metal shaped part pressed into the belt pulley, and the first and second axial stops include projections that extend radially inwards from the inner peripheral surface of the sleeve.

8. The belt pulley decoupler according to claim 6, further comprising an inner ring pressed onto the hub and an outer ring that receives the radial bearing ring, wherein the second spring plate is a sheet metal shaped part comprising a collar that connects an inner ring to the outer ring.

9. A belt pulley decoupler for an automotive engine, comprising:
a belt pulley;
a hub configured to be fixed on a shaft of an auxiliary drive unit driven by a belt;
a first spring plate having axially ramped spring support surfaces;
a second spring plate having axially ramped spring support surfaces; and
a torsion coil spring located between the belt pulley and the hub, the torsion coil spring extending about an axis of rotation of the belt pulley decoupler and configured to expand radially when subjected to drive torque, the torsion coil spring including a first end contacting the axially ramped spring support surfaces of the first spring, and a second end contacting the axially ramped spring support surfaces of the second spring;
wherein at least one of the spring plates has its respective axially ramped spring support surfaces formed thereon supporting the torsion coil spring.

10. The belt pulley decoupler of claim 9, wherein the axially ramped spring support surfaces of the first plate are curved about the axis of rotation and ramped to include inclined surfaces that incline with respect to the axis of rotation.

11. The belt pulley decoupler of claim 9, wherein the axially ramped spring support surfaces of the second plate are curved about the axis of rotation and ramped to include inclined surfaces that incline with respect to the axis of rotation.

12. The belt pulley decoupler of claim 9, wherein the axially ramped spring support surfaces of the first plate are circumferentially spaced from each other.

13. The belt pulley decoupler of claim 9, wherein the axially ramped spring support surfaces of the second plate are circumferentially spaced from each other.

14. The belt pulley decoupler of claim 9, further comprising a wrap-around band that wraps about the axis of rotation and is located radially between the belt pulley and the torsion coil spring, the wrap-around band having a first end contacting an inner peripheral surface of a sleeve that is rotationally fixed on the belt pulley, and a second end contacting an inner peripheral surface of the first spring plate.

15. The belt pulley decoupler of claim 14, wherein the first spring plate includes an integrally-formed projection extending axially outward therefrom.
